(19) United States
(12) Patent Application Publication
(10) Pub. No.: US 2018/0144438 A1
(43) Pub. Date: May 24, 2018

(54) IMAGE BLENDING APPARATUS AND METHOD THEREOF

(71) Applicant: Industrial Technology Research Institute, Hsinchu (TW)

(72) Inventors: Wei-Shuo Li, Hsinchu (TW); Jung-Yang Kao, Hsinchu (TW)

(21) Appl. No.: 15/390,318

(22) Filed: Dec. 23, 2016

(30) Foreign Application Priority Data
Nov. 18, 2016 (TW) 105137827

(51) Int. Cl. G06T 3/00

(52) U.S. Cl. CPC G06T 3/0012; G06T 2200/32

(57) ABSTRACT

An image blending apparatus and method thereof are provided. The image blending apparatus includes an image providing module providing a first image with a first overlap region and a second image with a second overlap region, and an image blending module generating a first gradient image of the first image and a second gradient image of the second image, calculating first distance weights of first pixels in the first overlap region of the first gradient image and second distance weights of second pixels in the second overlap region of the second gradient image, blending the first gradient image and the second gradient image into a blended gradient image according to the first distance weights of the first pixels and the second distance weights of the second pixels at respective corresponding positions, and restoring a blended image from the blended gradient image.

### CROSS-REFERENCE TO RELATED APPLICATION

The present disclosure is based on, and claims priority from Taiwan Application Number 105137827, filed on Nov. 18, 2016, the disclosure of which is hereby incorporated by reference herein in its entirety.

### TECHNICAL FIELD

The present disclosure relates to image blending apparatuses and methods thereof.

### BACKGROUND

In image blending or stitching, the most common unnatural phenomenon is the seams that appear in the blended images. Especially in the application of Virtual Reality (VR), usually pays special attention to reach the natural image so as not to cause fatigue in viewers' eyes. Moreover, in view of real-time considerations, a fast algorithm is also needed for seamless image blending.

In existing image blending or stitching techniques, multi-band blending, a (alpha) blending and Gradient-domain Image Stitching (GIST) are some of the commonly used techniques. Multi-band blending provides a better image blending effect, but takes a longer time to blend, therefore may not suitable for real-time applications. On the other hand, a blending has a shorter image blending time, but the effect of the image blending is poorer.

Furthermore, the time and effect of image blending of the GIST technique are between those of multi-band blending and those of a blending. However, in GIST, two images are used as reference values for an object function or a cost function, and a blending is used on the object function or a cost function, so its algorithm is still relatively complex, and may take longer stitching time upon blending images.

### SUMMARY

An exemplary embodiment in accordance with the present disclosure provides an image blending apparatus for an image processing system including a memory and a processor, the image blending apparatus comprising: an image providing module configured to provide a first image with a first overlap region and a second image with a second overlap region, the first overlap region and the second overlap region being an overlap region of the first image and the second image; and an image blending module configured to generate a first gradient image of the first image and a second gradient image of the second image, and calculate a first distance weight of each of a plurality of first pixels in the first overlap region of the first gradient image, and a second distance weight of each of a plurality of second pixels in the second overlap region of the second gradient image, wherein the image blending module is configured to blend the first gradient image and the second gradient image into a blended gradient image based on the first distance weight of each of the plurality of first pixels and the second distance weight of each of the plurality of second pixels at respective corresponding locations, and restore a blended image from the blended gradient image.

An exemplary embodiment in accordance with the present disclosure further provides an image blending method for an image processing system including a memory and a processor, the image blending method comprising: providing, by an image providing module, a first image with a first overlap region and a second image with a second overlap region, the first overlap region and the second overlap region being an overlap region of the first image and the second image; generating, by an image blending module, a first gradient image of the first image and a second gradient image of the second image; calculating, by the image blending module, a first distance weight of each of a plurality of first pixels in the first overlap region of the first gradient image, and a second distance weight of each of a plurality of second pixels in the second overlap region of the second gradient image; blending, by the image blending module, the first gradient image and the second gradient image into a blended gradient image based on the first distance weight of each of the plurality of first pixels and the second distance weight of each of the plurality of second pixels at respective corresponding locations; and restoring, by the image blending module, a blended image from the blended gradient image.

### BRIEF DESCRIPTION OF THE DRAWINGS

FIG. 1 is a block diagram depicting an image blending apparatus 1 in accordance with the present disclosure;

FIG. 2 is a flowchart illustrating an image blending method in accordance with an embodiment of the present disclosure;

FIGS. 3A to 3D are schematic diagrams illustrating an image blending method in accordance with an embodiment of the present disclosure; and

FIGS. 4A to 4G are schematic diagrams illustrating an image blending method in accordance with an embodiment of the present disclosure.

### DETAILED DESCRIPTION OF EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

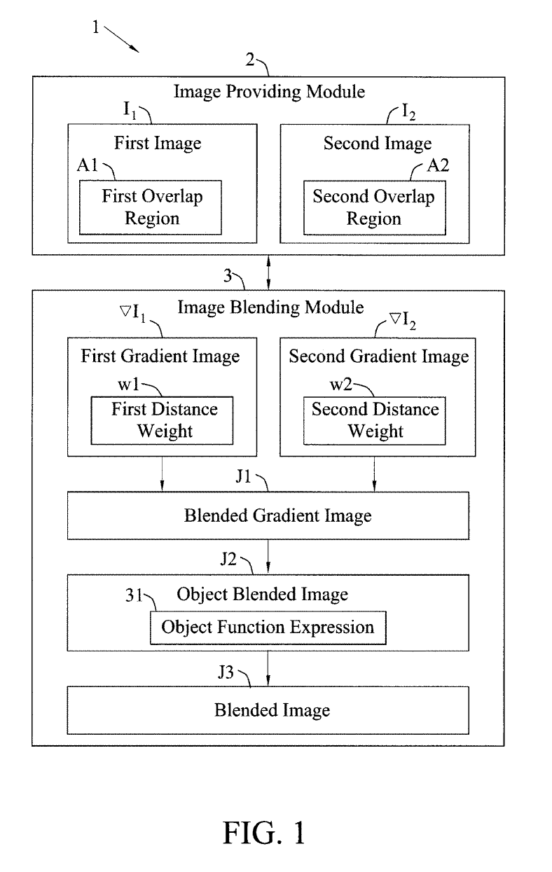

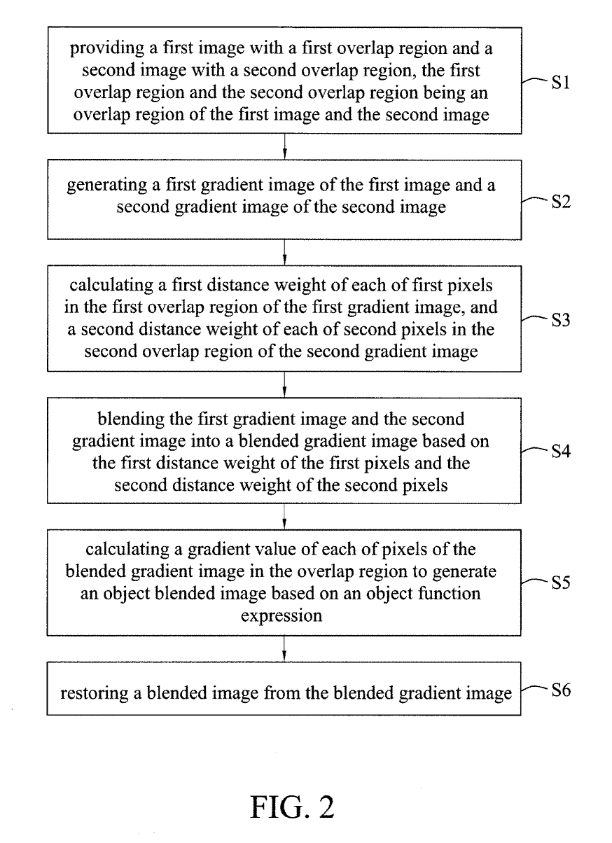

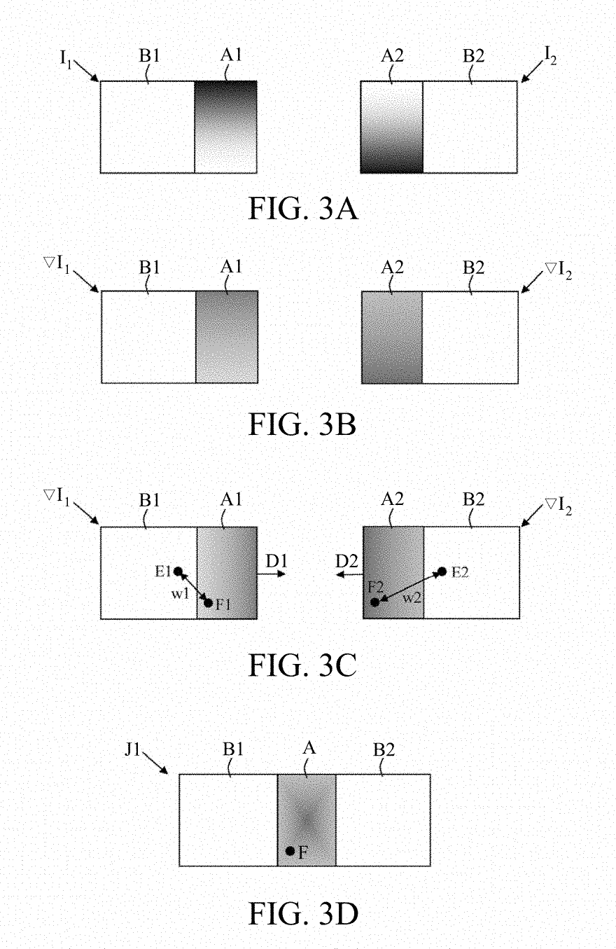

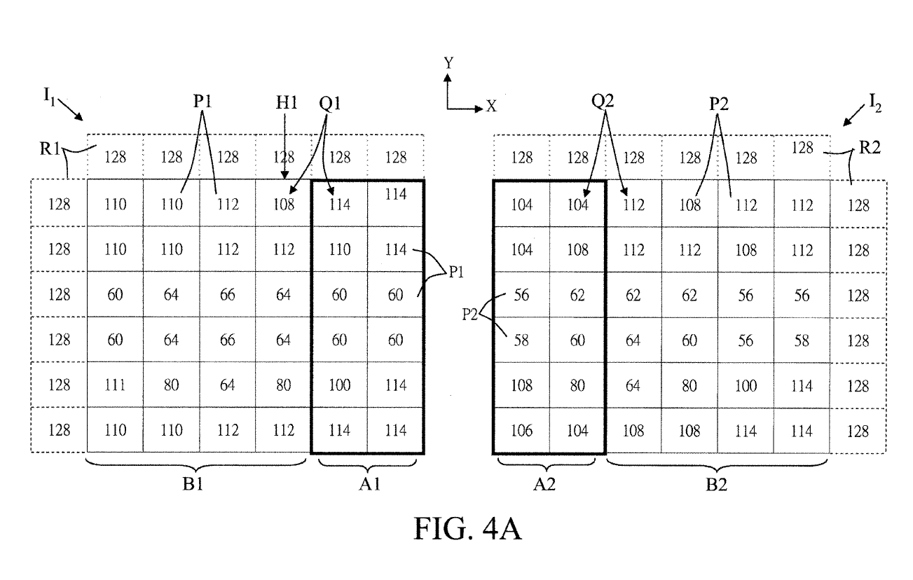

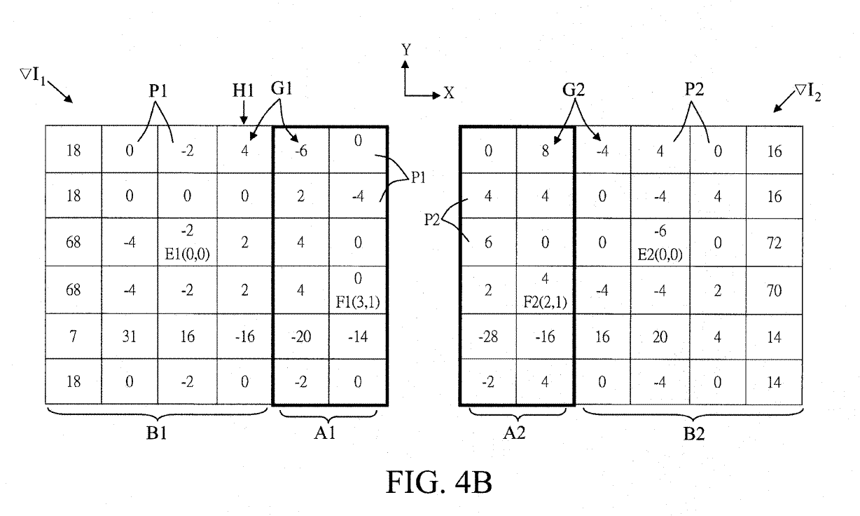

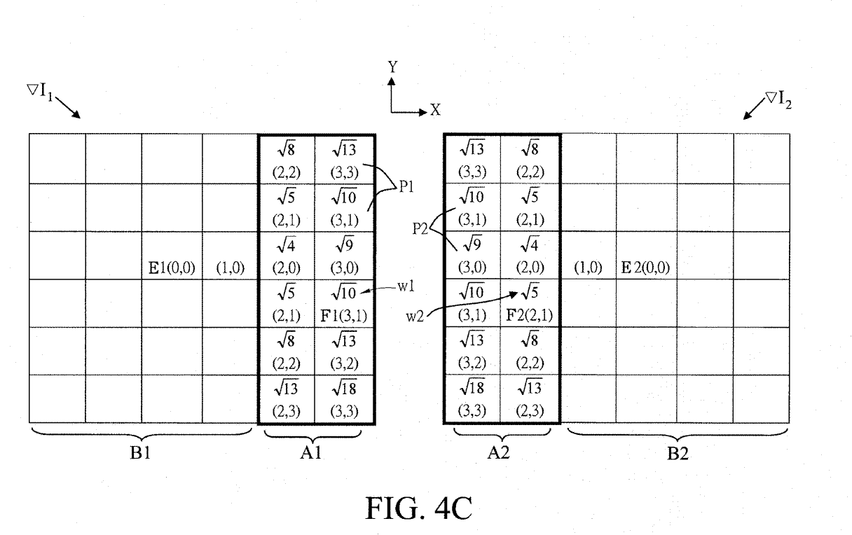

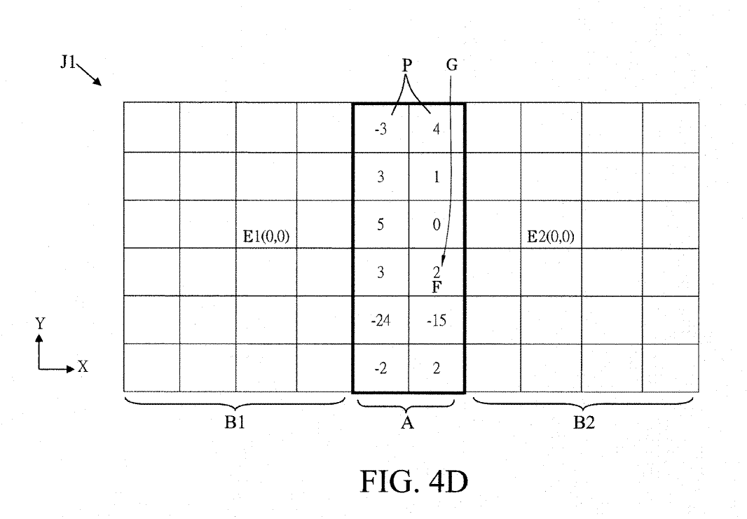

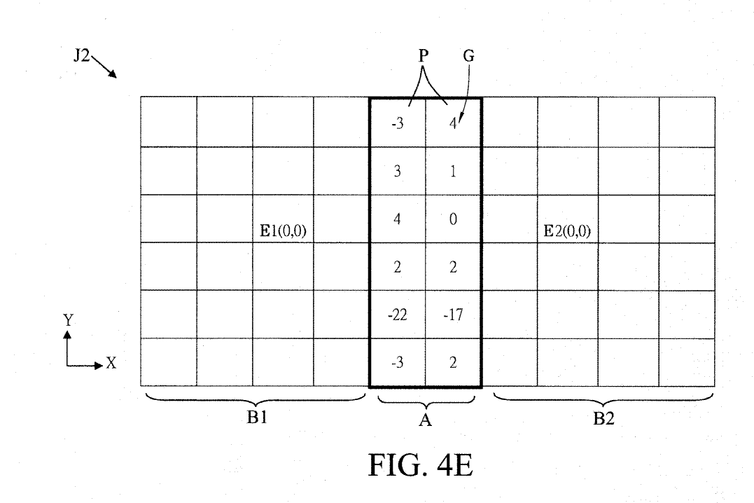

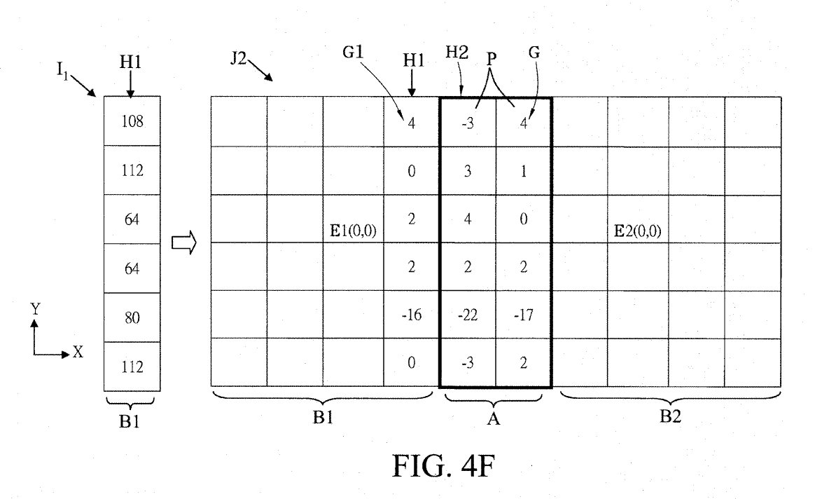

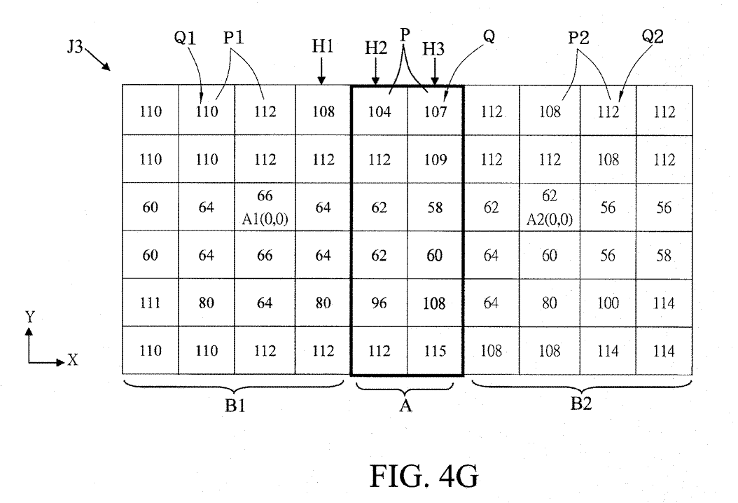

FIG. 1 is a block diagram depicting an image blending apparatus 1 in accordance with the present disclosure. FIG. 2 is a flowchart illustrating an image blending method in accordance with an embodiment of the present disclosure. FIGS. 3A to 3D are schematic diagrams illustrating an image blending method in accordance with an embodiment of the present disclosure. FIGS. 4A to 4G are schematic diagrams illustrating an image blending method in accordance with an embodiment of the present disclosure.

As shown in the embodiments with respect to FIGS. 1 and 2, the image blending apparatus 1 and the image blending method are applicable to an image processing system (not shown) comprising a memory and a processor, and includes an image providing module 2 and an image blending module 3. In an embodiment, the image providing module 2 is, but not limited to, at least one of an image capturing device, an image capturing card, a storage, a memory, a memory card, or a combination of the above, the storage is, but not limited to, at least one of a hard disk, a floppy disk, a CD or a flash drive, and the image blending module 3 is, but not limited to, at least one of an image processor, an image processing software, or a combination of the above.

As shown in the embodiments of FIGS. 1, 2, 3A and 4A, in step S1 of FIG. 2, the image providing module 2 provides a first image I₁ with a first overlap region A1 and a first non-overlap region B1, and a second image I₂ with a second overlap region A2 and a second non-overlap region B2. The first overlap region A1 and the second overlap region A2 are an overlap region A of the first image I₁ and the second image I₂ (see FIG. 3D or 4D).

In the embodiment of FIG. 4A, the first image I₁ includes a plurality of first pixels P1 having first pixel values Q1, without including a plurality of first reference values R1. The second image I₂ includes a plurality of second pixels P2 having second pixel values Q2, without including a plurality of second reference values R2. The first reference values R1 or the second reference values R2 can, for example, assume any numerical value between 0 and 255. This embodiment uses the average value (middle value) 127 between the numerical values 0 and 255 as an example.

As shown in the embodiments of FIGS. 1, 2, 3B and 4B, in step S2 of FIG. 2, the image blending module 3 generates a first gradient image ∇I₁ of the first image I₁ and a second gradient image ∇I₂ of the second image I₂.

In the embodiment of FIG. 4B, the image blending module 3 calculates a first gradient value G1 of each of the plurality of first pixels P1 in the first gradient image ∇I₁ of FIG. 4B based on the plurality of first reference values R1 and the respective first pixel values Q1 of the plurality of first pixels P1 in the first image I₁ in FIG. 4A, and calculates a second gradient value G2 of each of the plurality of second pixels P2 in the second gradient image ∇I₂ of FIG. 4B based on the plurality of second reference values R2 and the respective second pixel values Q2 of the plurality of second pixels P2 in the second image I₂ in FIG. 4A. In the embodiment of FIG. 4A or FIG. 4B, the plurality of first pixels P1 can be all of the pixels of the first image I₁ or the first gradient image ∇I₁, and the plurality of second pixels P2 can be all of the pixels of the second image I₂ or the second gradient image ∇I₂.

In an embodiment, a plurality of first gradient values G1 along the x-axis in the first gradient image ∇I₁ and a plurality of second gradient values G2 along the x-axis in the second gradient image ∇I₂ are derived as follows. In the first gradient image ∇I₁ of FIG. 4B, the image blending module 3 subtracts a first reference value R1 (i.e., 128) on the top left corner of FIG. 4A by a first pixel value Q1 (i.e., 110) of the first image I₁ in the top left corner of FIG. 4A to arrive at a corresponding first gradient value G1 (i.e., 18) on the top left corner of FIG. 4B. Similarly, the image blending module 3 may then subtract the aforementioned first pixel value Q1 (i.e., 110) of the first image I₁ in FIG. 4A by a first pixel value Q1 (i.e., 110) on its immediate right to arrive at a corresponding first gradient value G1 (i.e., 0) of FIG. 4B; and so on.

In the second gradient image ∇I₂ of FIG. 4B, the image blending module 3 subtracts a second reference value R2 (i.e., 128) on the top right corner of FIG. 4A by a second pixel value Q2 (i.e., 112) of the second image I₂ in the top left corner of FIG. 4A to arrive at a corresponding second gradient value G2 (i.e., 16) on the top right corner of FIG. 4B. Similarly, the image blending module 3 may then subtract the aforementioned second pixel value Q2 (i.e., 112) of the second image I₂ in FIG. 4A by a second pixel value Q2 (i.e., 112) on its immediate left to arrive at a corresponding second gradient value G2 (i.e., 0) of FIG. 4B; and so on.

Similarly, in accordance with the above method of calculation, a plurality of first gradient values G1 along the y-axis in the first gradient image ∇I₁ and a plurality of second gradient values G2 along the y-axis in the second gradient image ∇I₂ can be further derived, details of which are omitted.

As shown in the embodiments of FIGS. 1, 2, 3C and 4C, in step S3 of FIG. 2, the image blending module 3 calculates a respective first distance weight w1 for each of the plurality of first pixels P1 in the first overlap region A1 of the first gradient image ∇I₁ and a respective second distance weight w2 for each of the plurality of second pixels P2 in the second overlap region A2 of the second gradient image ∇I₂.

In the embodiment of FIG. 4C, the image blending module 3 calculates a respective first distance weight w1 of each of the plurality of first pixels P1 based on a distance between the plurality of first pixels P1 in the first overlap region A1 of the first gradient image ∇I₁ and a first center point E1 of the first gradient image ∇I₁, and calculates a respective second distance weight w2 of each of the plurality of second pixels P2 based on a distance between the plurality of second pixels P2 in the second overlap region A2 of the second gradient image ∇I₂ and a second center point E2 of the first gradient image ∇I₁.

In an embodiment, the coordinates (X, Y) of the first center point E1 of FIG. 4C are (0, 0), the coordinate (X, Y) of a first pixel point F1 are (3, 1), and the first distance weight w1 of the first pixel point F1 is equal to \sqrt{(3−0)²+(1−0)²}=\sqrt{10}. Similarly, the coordinate (X, Y) of the second center point E2 of FIG. 4C is (0, 0), the coordinate (X, Y) of a second pixel point F2 is (2, 1), and the second distance weight w2 of the second pixel point F2 is equal to \sqrt{(2−0)²±(1−0)²}=\sqrt{5}; and so on.

As shown in the embodiments of FIGS. 1, 2, 3D and 4D, in step S4 of FIG. 2, the image blending module 3 blends the first image I₁ and the second image I₂ of FIG. 3C (FIG. 4C) into a blended gradient image J1 of FIG. 3D (FIG. 4D) according to a direction D1 and a direction D2 based on the respective first distance weight w1 of each of the plurality of first pixels P1 in FIGS. 3C (4C) and the second distance weight w2 of each of the plurality of second pixels P2 in FIGS. 3C (4C) at respective corresponding locations (or coordinates).

In the embodiment of FIG. 4D, the image blending module 3 calculates a gradient value G of each of the plurality of pixels P of the blended gradient image J1 in the overlap region A of FIG. 4D based on the first gradient value G1 of each of the plurality of first pixels P1 in the first overlap region A1 of the first gradient image ∇I₁ of FIG. 4B, the second gradient value G2 of each of the plurality of second pixels P2 in the second overlap region A2 of the second gradient image ∇I₂ of FIG. 4B, and the first distance weight w1 of each of the plurality of first pixels P1 and the second distance weight w2 of each of the plurality of second pixels P2 of FIG. 4C.

In an embodiment, using a pixel point F in the overlap region A of FIG. 4D (i.e., a pixel point F overlapping the first pixel point F1 and the second pixel point F2 in FIG. 4B and FIG. 4C) for illustration, the image blending module 3 adds “a product of the first gradient value G1 (i.e., 0) of the first pixel point F1 in FIG. 4B and the second distance weight w2 (i.e., \sqrt{5} of the second pixel point F2 in FIG. 4C” and “a product of the second gradient value G2 (i.e., 4) of the second pixel point F2 in FIG. 4B and the first distance weight w1 (i.e., \sqrt{10})) of the first pixel point F1 in FIG. 4C” together before dividing it by “a sum of the second distance weight w2 (i.e., \sqrt{5}) of the second pixel point F2 in FIG. 4C and the first distance weight w1 (i.e., \sqrt{10}) of the first pixel point F1 in FIG. 4C” to obtain the gradient value G of the pixel point F in FIG. 4D (about 2), that is, according to the equation below, and this is applicable to other pixels.

((0*\sqrt{5})+(4*\sqrt{10}))/(\sqrt{5}+\sqrt{10}))=2.36≈2

As shown in the embodiments of FIGS. 1, 2, and 4E, in step S5 of FIG. 2, the image blending module 3 calculates the gradient value G of each of the plurality of pixels P in the overlap region A of the blended gradient image J1 of FIG. 4D to generate an object blended image J2 of FIG. 4E based on the following object function expression 31 (or cost function expression):

$$min {\sum }_{q} {‖ ∇ \hat{I} ( q ) - ∇ C ( q ) ‖}_{2}$$

wherein min is minimization, q is the coordinate (X, Y) of a respective pixel P in the overlap region A of the blended gradient image J1 of FIG. 4D, ∇Î(q) is a respective gradient value G of the plurality of pixels P in the overlap region A of the object blended image J2 of FIG. 4E, and ∇C(q) is a respective gradient value G of the plurality of pixels P in the overlap region A of the blended gradient image J1 of FIG. 4D.

In an embodiment, step S5 of FIG. 2 (FIG. 4E) is omitted, and the method proceeds all the way to step S6 of FIG. 2 (FIGS. 4F and 4F) from step S4 of FIG. 2 (FIG. 4D), such that the image blending module 3 restores a blended image J3 of FIG. 4G from the blended gradient image J1 of FIG. 4D, as will be described below.

As shown in the embodiments of FIGS. 1, 2, 4F and 4G, in step S6 of FIG. 2, the image blending module 3 restores the blended image J3 of FIG. 4G from the object blended image J2 of FIG. 4E.

In the embodiments of FIG. 4F and FIG. 4G, the image blending module 3 calculates the pixel value Q of each of the plurality of pixels P in the blended image J3 of FIG. 4G based on the first pixel values Q1 of the plurality of first pixels P1 (e.g., the first pixels P1 in column H1) in the first non-overlap region B1 of the first image I₁ of FIG. 4A, the first gradient values G1 of the plurality of first pixels P1 (e.g., the first pixels P1 in column H1) in the first non-overlap region B1 of the first image I₁ of FIG. 4A, and the gradient values G of the plurality of pixel values P in the overlap region A of the object blended image J2 of FIG. 4E.

In an embodiment, using column H2 of the overlap region A of FIG. 4G for illustration, the image blending module 3 fills the column H1 of the object blended image J2 of FIG. 4F with the first gradient value G1 (e.g., 4, 0, 2, 2, −16, 0) in a column H1 of the first gradient image ∇I₁ of FIG. 4B, and subtracts the first pixel values Q1 in the column H1 of first image I₁ of FIG. 4A (e.g., 108, 112, 64, 64, 80, 112) by their corresponding first gradient values G1 (e.g., 4, 0, 2, 2, −16, 0) in the column H1 of the object blended image J2 of FIG. 4F to get pixel values Q (e.g., 104, 112, 62, 62, 96, 112) of the plurality of pixels P in a column H2 of the overlap region A of the blended image J3 of FIG. 4G.

Furthermore, the image blending module 3 then subtracts the pixel values Q (e.g., 104, 112, 62, 62, 96, 112) of the plurality of pixels P in the column H2 of the overlap region A of the blended image J3 of FIG. 4G by their corresponding gradient values G (e.g., −3, 3, 4, 2, −22, −3) in a column H2 of the object blended image J2 of FIG. 4F to get pixel values Q (e.g., 107, 109, 58, 60, 108, 115) of the plurality of pixels Pin a column H3 of FIG. 4G In an embodiment, the image blending module 3 fills the first non-overlap region B1 of FIG. 4G with the first pixel values Q1 of the plurality of first pixels P1 in the first non-overlap region B1 of the first image I₁ of FIG. 4A, and fills the second non-overlap region B2 of FIG. 4G with the second pixel values Q2 of the plurality of second pixels P2 in the second non-overlap region B2 of the second image I₂ of FIG. 4A, thereby creating the blended image J3 of FIG. 4G.

It can be appreciated from the above that the image blending apparatus and method thereof according to the present disclosure employ techniques, such as gradient images and distance weights, to achieve a seamless blended image, a shorter time for blending images, and a better image blending effect. In addition, a simpler cost function expression can be used to achieve real-time or faster blending of at least two images.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image blending apparatus for an image processing system comprising a memory and a processor, the image blending apparatus comprising:
an image providing module configured to provide a first image with a first overlap region and a second image with a second overlap region, the first overlap region and the second overlap region being an overlap region of the first image and the second image; and
an image blending module configured to generate a first gradient image of the first image and a second gradient image of the second image, and calculate a first distance weight of each of a plurality of first pixels in the first overlap region of the first gradient image, and a second distance weight of each of a plurality of second pixels in the second overlap region of the second gradient image,
wherein the image blending module is configured to blend the first gradient image and the second gradient image into a blended gradient image based on the first distance weight of each of the plurality of first pixels and the second distance weight of each of the plurality of second pixels at respective corresponding locations, and restore a blended image from the blended gradient image.

2. The image blending apparatus of claim 1, wherein the image providing module is at least one of an image capturing device, an image capturing card, a storage, a memory, a memory card, or a combination thereof.

3. The image blending apparatus of claim 1, wherein the image blending module is at least one of an image processor, an image processing software, or a combination thereof.

4. The image blending apparatus of claim 1, wherein the image blending module is configured to further calculate a first gradient value for each of the plurality of first pixels in the first gradient image based on a plurality of first reference values and respective first pixel values of the plurality of first pixels in the first image, and calculate a second gradient value for each of the plurality of second pixels in the second gradient image based on a plurality of second reference values and respective second pixel values of the plurality of second pixels in the second image.

5. The image blending apparatus of claim 1, wherein the image blending module is configured to further calculate the first distance weight of each of the plurality of first pixels based on a distance between the plurality of first pixels in the first overlap region of the first gradient image and a first center point of the first gradient image, and calculate the second distance weight of each of the plurality of second pixels based on a distance between the plurality of second pixels in the second overlap region of the second gradient image and a second center point of the second gradient image.

6. The image blending apparatus of claim 1, wherein the image blending module is configured to further calculate a gradient value for each of a plurality of pixels in an overlap region of the blended gradient image based on a first gradient value of each of the plurality of first pixels in the first overlap region of the first gradient image, a second gradient value of each of the plurality of second pixels in the second overlap region of the second gradient image, the first distance weight of each of the plurality of first pixels and the second distance weight of each of the plurality of second pixels.

7. The image blending apparatus of claim 1, wherein the image blending module is configured to further calculate a gradient value of each of the plurality of pixels in an overlap region of the blended gradient image to generate an object blended image based on an object function expression below, and restore the blended image from the object blended image,
$$min {\sum }_{q} {‖ ∇ \hat{I} ( q ) - ∇ C ( q ) ‖}_{2}$$
wherein min is a minimization function, q is a coordinate (X, Y) of each of the plurality of pixels in the overlap region of the blended gradient image, ∇Î(q) is a gradient value of each of a plurality of pixels in an overlap region of the object blended image, and ∇C(q) is the gradient value of each of the plurality of pixels in the overlap region of the blended gradient image.

8. The image blending apparatus of claim 1, wherein the image blending module is configured to further calculate a pixel value of each of a plurality of pixels in an overlap region of the blended image based on a first pixel value of each of the plurality of first pixels in a first non-overlap region of the first image, a first gradient value of each of the plurality of first pixels in the first non-overlap region of the first gradient image, and a gradient value of each of a plurality of pixels in an overlap region of an object blended image.

9. An image blending method for an image processing system comprising a memory and a processor, the image blending method comprising:
providing, by an image providing module, a first image with a first overlap region and a second image with a second overlap region, the first overlap region and the second overlap region being an overlap region of the first image and the second image;
generating, by an image blending module, a first gradient image of the first image and a second gradient image of the second image;
calculating, by the image blending module, a first distance weight of each of a plurality of first pixels in a first overlap region of the first gradient image, and a second distance weight of each of a plurality of second pixels in a second overlap region of the second gradient image;
blending, by the image blending module, the first gradient image and the second gradient image into a blended gradient image based on the first distance weight of each of the plurality of first pixels and the second distance weight of each of the plurality of second pixels at respective corresponding locations; and
restoring, by the image blending module, a blended image from the blended gradient image.

10. The image blending method of claim 9, further comprising calculating, by the image blending module, a first gradient value for each of the plurality of first pixels of the first gradient image based on a plurality of first reference values and respective first pixel values of the plurality of first pixels of the first image, and calculating a second gradient value for each of the plurality of second pixels of the second gradient image based on a plurality of second reference values and respective second pixel values of the plurality of second pixels of the second image.

11. The image blending method of claim 9, further comprising calculating, by the image blending module, the first distance weight of each of the plurality of first pixels based on a distance between the plurality of first pixels in the first overlap region of the first gradient image and a first center point of the first gradient image, and calculating the second distance weight of each of the plurality of second pixels based on a distance between the plurality of second pixels in the second overlap region of the second gradient image and a second center point of the second gradient image.

12. The image blending method of claim 9, further comprising calculating, by the image blending module, a gradient value for each of a plurality of pixels in an overlap region of the blended gradient image based on a first gradient value of each of the plurality of first pixels in the first overlap region of the first gradient image, a second gradient value of each of the plurality of second pixels in the second overlap region of the second gradient image, the first distance weight of each of the plurality of first pixels and the second distance weight of each of the plurality of second pixels.

13. The image blending method of claim 9, further comprising calculating, by the image blending module, a gradient value of a plurality of pixels in an overlap region of the blended gradient image to generate an object blended image based on an object function expression below, and restoring, by the image blending module, the blended image from the object blended image,
$$min {\sum }_{q} {‖ ∇ \hat{I} ( q ) - ∇ C ( q ) ‖}_{2}$$
wherein min is a minimization function, q is a coordinate (X, Y) of each of the plurality of pixels in the overlap region of the blended gradient image, ∇Î(q) is a gradient value of each of a plurality of pixels in an overlap region of the object blended image, and ∇C(q) is the gradient value of each of the plurality of pixels in the overlap region of the blended gradient image.

14. The image blending method of claim 9, further comprising calculating, by the image blending module, a pixel value of each of a plurality of pixels in an overlap region of the blended image based on a first pixel value of each of the plurality of first pixels in a first non-overlap region of the first image, a first gradient value of each of the plurality of first pixels in the first non-overlap region of the first gradient image, and a gradient value of each of a plurality of pixels in an overlap region of an object blended image.
